(19) United States
(12) Patent Application Publication
(10) Pub. No.: US 2017/0297296 A1
(43) Pub. Date: Oct. 19, 2017

(54) NONWOVEN, METHOD OF MAKING SAME, AND USES OF SAME

(71) Applicant: Kem-Wove Inc., Charlotte, NC (US)

(72) Inventor: Steven Sklow, Woodcliff Lake, NJ (US)

(73) Assignee: Kem-Wove Inc.

(21) Appl. No.: 15/479,343

(22) Filed: Apr. 5, 2017

Related U.S. Application Data
(60) Provisional application No. 62/322,403, filed on Apr. 14, 2016.

(51) Int. Cl. B32B 5/14; B32B 7/12; B32B 37/06; D04H 1/541; E04H 15/54; D04H 1/558; B32B 5/02; B32B 5/26; B32B 37/12

(52) U.S. Cl. CPC B32B 5/145; B32B 5/26; B32B 7/12; B32B 37/06; B32B 37/12; E04H 15/54; D04H 1/558; B32B 5/022; D04H 1/541; B32B 2260/023; B32B 2260/046; B32B 2305/28; B32B 2307/722; D10B 2505/18; B32B 2262/12

(57) ABSTRACT

A method for covering a portable structure, the portable structure having a frame and a covering, includes the step of: providing the covering, the covering includes a nonwoven having a densified portion on a first face of the nonwoven and a lofty portion on a second face of the nonwoven, and a skin laminated on the nonwoven, or a first nonwoven having a densified portion and a lofty portion, a second nonwoven having a densified portion and a lofty portion, and a skin laminated on the first nonwoven or the second nonwoven.

### RELATED APPLICATION

This application claims the benefit of co-pending Provisional Patent Application Ser. No. 62/322,403 filed Apr. 14, 2016, incorporated herein by reference.

### FIELD OF THE INVENTION

The instant invention is directed to a nonwoven, its method of manufacture, and uses thereof.

### BACKGROUND OF THE INVENTION

Nonwovens are used in a variety of applications. Nonwovens can be tailored to have a lightweight as well as other properties. Such properties may include, but are not limited to, inflammability, and/or insulative, and/or strength, and/or durability.

For example, one application is in a portable structure (e.g., a tent or a large tent intended to house a work space, such a command and control center for a military operation). In this application, the tent needs to be lightweight, but strong and have the ability to be inflammable and insulative, because the tent may be moved to various locations and be set in varying environment with the need to control the internal environment (e.g. heat, cool, humidity) of the work space. The nonwoven can be used in the tent covering to meet the requirements.

Accordingly, there is a need for new nonwovens that can be used in a variety of applications and the method of manufacturing those nonwovens.

### SUMMARY OF THE INVENTION

A method for covering a portable structure, the portable structure having a frame and a covering, includes the step of: providing the covering, the covering includes a nonwoven having a densified portion on a first face of the nonwoven and a lofty portion on a second face of the nonwoven, and a skin laminated on the nonwoven, or a first nonwoven having a densified portion and a lofty portion, a second nonwoven having a densified portion and a lofty portion, and a skin laminated on the first nonwoven or the second nonwoven.

### DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is an isometric view of an exemplary portable structure.

FIGS. 2A and 2B are elevational views of a cross-section of exemplary coverings of the portable structure.

FIGS. 3A, 3B, and 3C are illustrations of various embodiments of the nonwoven.

FIG. 4 show a flow chart of an embodiment of the manufacturing steps used to produce the nonwoven.

### DESCRIPTION OF THE INVENTION

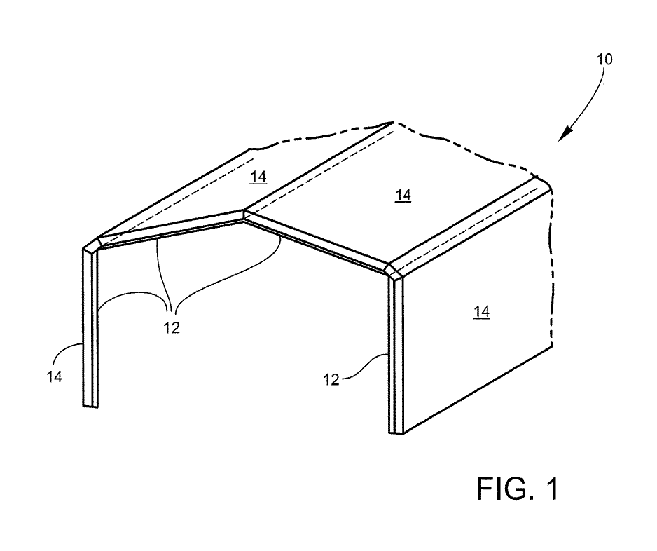

Referring to the drawings, wherein like elements have like numerals, there is shown in FIG. 1 an exemplary portable structure (e.g., a tent) 10.

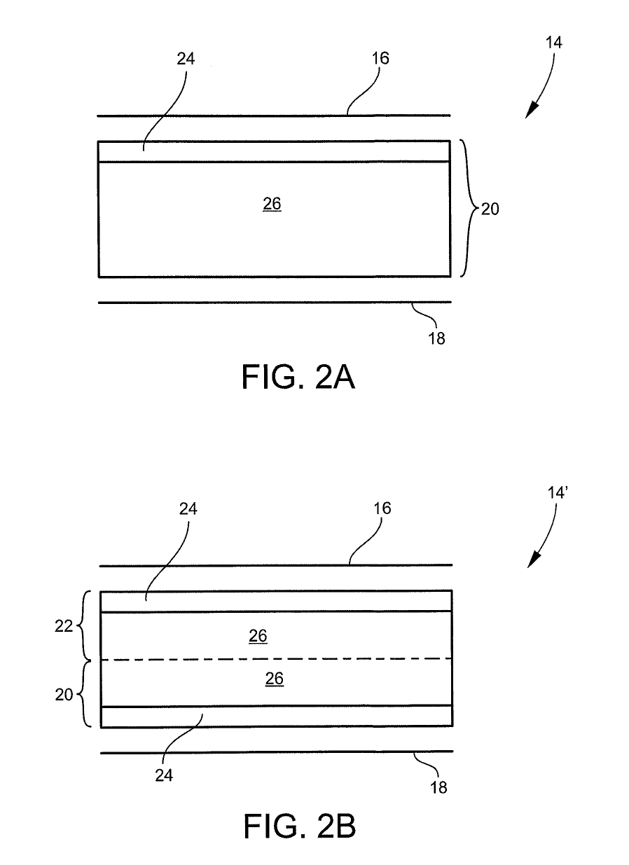

Portable structure 10 may be any portable structure, for example, a tent, such as those used in desert or frigid environments, used to house, for example, a work space (e.g., a command and control center for a military operation). Structure 10 includes a frame 12 and a covering 14. The covering 14 is supported by the frame 12. In general, covering 14 may include: a nonwoven 20 with an exterior (or external) skin 16 and/or an interior (or internal) skin 18, FIG. 2A; or a first nonwoven 20, second nonwoven 22, with an exterior (or external) skin 16 and/or an interior (or internal) skin 18, FIG. 2B.

The covering 14 is lightweight, sturdy, and provides a good insulation value (R). Moreover, the covering 14 may be rolled or folded, for storage and/or for transportation, and still maintain the insulation value. Covering 14 may have a skin on one or both outside surfaces of the nonwoven. Skins 16 and/or 18 may be made of any material. Skins 16 and/or 18 may be films, and nonwovens, and/or coating and/or a laminate, or combinations thereof. Skins 16 and/or 18 may be: water and/or moisture impermeable and/or repelling, and/or chemical impermeable and/or repelling (impermeable may be either partially blocking or totally blocking; repelling may be having an ability to shed and/or resist passage or absorption).

Nonwoven 20 and 22 generally include a densified portion 24 and a lofty portion 26 (both discussed below). Nonwoven 20 and 22 may be made by laminating a densified nonwoven to a lofty nonwoven and/or with a nonwoven structure (discussed below).

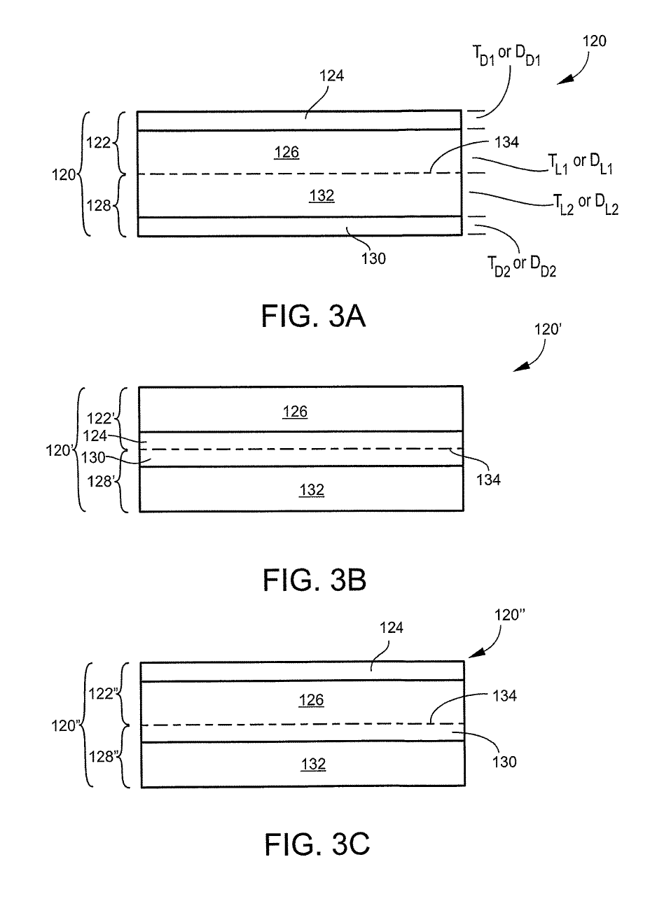

The nonwoven structure 120 (see, for example, FIGS. 3A, 3B, and 3C—showing several embodiments) generally includes: a first batt 122 laminated to a second batt 128 via lamination (or bond) line 134. In general, each batt may be a blend of staple fibers (or may be several batts of differing staple fiber blends). Each batt has densified portion (or skin) 124, 130 on one face of the batt and a lofty portion (or body) 126, 132 on the other face of the batt. The densified portion may have: a greater fiber density D_{D} than the fiber density D_{L} of the lofty portion; and/or the fibers are more compact (e.g., less air space) than in the lofty portion. Fiber density refers to the number of fibers per unit volume. Densification/compaction may be obtained by, for example, needling, where the densified portion is needled and the lofty portion is not needled or needled to a lesser extent than the densified portion, or by use of varying amounts of bicomponent fibers or resin in portions of the batt. Each batt may be made of an integral mass of fibers (or one or more layered balls of differing fiber or blends) in which a portion of the fiber mass is densified and a remaining portion is lofty (e.g., undensified or less densified). This densified/lofty batt may not be a laminate of a densified batt and a lofty batt (i.e., where each of these batts is made separately and subsequently laminated together, referring the manufacturing discussion below for greater detail on the method of manufacture) or may be a laminate of a densified batt and a lofty batt. Each of the foregoing elements will be discussed in greater detail below.

The nonwoven structure 120 may have any basis weight. The nonwoven structure may have any density (e.g., fiber) for the densified portion and/or the lofty portion. The nonwoven structure may have any ratio of density, thickness and/or basis weight between the densified portion and the lofty portion.

Batt, as used herein, refers to a blend of staple fibers that are loosely held together (held together with sufficient strength, so that the batt may be processed, as is understood by those of ordinary skill, but is not consolidated or bonded yet), or one or more batts laid up on one another, the individual batts may be of the same or differing fibers (e.g., differing materials and/or deniers). In batt formation, it is possible to vary fiber composition (from bottom to top) via the formation technique (e.g., fibers of greater denier at the bottom and lesser denier at the top). The staple fiber may be any staple fiber made of any natural or synthetic material. Synthetic materials may be thermoplastic or solution spun. The synthetic material may be made of, for example, polyolefin, polyester, acrylic, modacrylic, melamine, PBI, PBO, amide, amine, carbon oxidized PAN (e.g., OX fiber), rayon, novoloid, PPS, PAI, aramid, polyimide, fluoro carbon (e.g., PTFE)and the like, and blends thereof). The batt may be formed in any conventional manner. Examples include: air-laying (e.g., Rando-Webber-type machine), carding or dry-laying (including carding with cross-lapping), but may exclude wet-laying. These terms are conventional as shown by reference to: Dictionary of Fiber & Textile Technology, 7^{th} edition, published by KOSA, Charlotte, N.C. (1999), and/or www.engr.utk.edu/mse/Textiles by Larry C. Wadsworth (editor), both incorporated herein by reference.

Densified portion (or skin) 124, 130 refers to a portion of the batt that is consolidated or densified or compacted. For example, the batt may be partially consolidated or densified or compacted in any conventional manner. Consolidated or densified or compacted may be obtained by the use of bi-component fibers, resin, or both (with heat and/or pressure), and/or needling. Only a portion of the thickness of the batt is consolidated or densified or compacted. For example, see FIG. 3A, first batt 22 has a densified portion 24 and a lofty portion 26. Densified portion 24 has a thickness (T_{D1}) and/or a fiber density (D_{D1}).

Lofty portion (or body) 26, 32 refers to a portion of the batt that is not consolidated or densified or compacted (meaning not consolidated/densified/compacted as the densified portion 24, 30, but may include some inter-fiber bonding effected by, for example, the use of bi-component fibers and/or resin) or is less consolidated or densified or compacted than the densified portion. Only a portion of the thickness of the batt remains lofty. For example see FIG. 3A, first batt 22 has a densified portion 24 and a lofty portion 26. Lofty portion 26 has a thickness (T_{L1}) and/or a fiber density (D_{L1}).

In general: for each batt, D_{D} is greater than D_{L}, T_{D} may be the same or different from I_{L}; and for each nonwoven structure. D_{D1} may be the same as or different from D_{D2} and T_{D1} may be the same or different from T_{D2}.

In a single batt, for example batt 122, the thickness and/or density may be altered to achieve a desired set of properties. For example, in one application, strength may be desired over insulation value (R), so the densified portion may be thicker and/or more dense than in another application.

The first batt and the second batt may be the same or different. For example, the staple fibers may the same or different. The thickness (T) and/or fiber density (D) of the densified and lofty portions may be same or different.

Laminate (laminate bond 34), as used herein, refers to bonding the first batt to the second batt (i.e., a face of the first batt is bonded to a face of the second batt). This bonding may be any conventional bonding, for example via adhesives (applied in any manner), and/or via heat activable materials (e.g., bi-component fibers and/or resins, and/or scrims), and/or sewing.

FIG. 3A illustrates the lofty portions 26 and 32 are bonded in face-to-face contact. FIG. 3B illustrates densified portions 24 and 30 bonded in face-to-face contact. FIG. 3C illustrates lofty portion 26 bonded in face-to-face contact with densified portion 30. Bonding in face-to-face contact refers to continuous bonding over the entire face or partial bonding (e.g., lines dots, etc.) over the entire face.

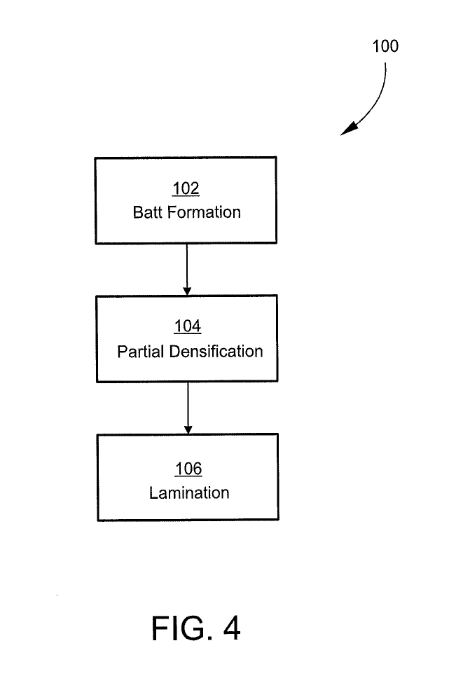

FIG. 4 illustrates the process 100 for making the nonwoven structure 20. In general, the process includes the steps of: forming the batts 102; partially densifying a portion of the each batt 104; and laminating the batts together 106.

Forming each batt 102 may be accomplished in any manner. Forming the batt may include, examples include: air-laying (e.g., Rando-Webber -type machine), carding or dry-laying (including carding with cross-lapping), but may exclude wet-laying. These terms are conventional as shown by reference to: Dictionary of Fiber & Textile Technology, 7^{th} edition, published by KOSA, Charlotte, N.C. (1999), and/or www.engr.utk.edu/mse/Textiles by Larry C. Wadsworth (editor), both incorporated herein by reference. The batt may be a single mass of fibers or one or more layer of batts.

Densifying (or consolidating) a portion of the batt 104 may be accomplished in any manner. Densifying (or consolidating or compacting) a portion of the batt (partially consolidating) may include, for example: needling, and/or heated nip rollers to activate bi-component fibers and/or resin, and/or oven to activate bi-component fibers and/or resin, and/or a heated belt to activate bi-component fibers and/or resin. When needling the needle depth penetration, speed of needling, and needle (e.g., barb configuration—size of barb and location of barb on the needle) may be varied to obtain the desired densified and lofty portions. When one of more layers batts are used to form the batt, densifying must penetrate into the total batt sufficiently, so that the individual batts are held together and the formed batt has a densified portion and a lofty portion. The densified/lofty batt is not made by making a densified layer and a lofty layer and then laminating those layers together.

Laminating one batt to the other batt 106 may be accomplished in any conventional manner. For example, adhesives (applied in any manner), and/or via heat activable materials (e.g., bi-component fibers and/or resins, and/or scrims), and/or sewing.

Alternate expressions of the invention may include:

A nonwoven structure comprising: a first batt is a blend of staple fibers, the first batt has a densified portion on a first face of the first batt and a lofty portion on a second face of the first batt, where the densified portion and the lofty portion are formed from the fibers of the first batt and are not layers laminated together; a second batt is a blend of staple fibers, the second batt has a densified portion on a first face of the second batt and a lofty portion on a second face of the second batt, where the densified portion and the lofty portion are formed from the fibers of the second batt and are not layers laminated together; and the first batt is laminated to the second batt. The foregoing nonwoven structure wherein the staple fibers are a single staple fiber or a blend of two or more staple fibers. The foregoing nonwoven structure wherein the staple fibers include low melt temperature fibers or bi-component fibers. The foregoing nonwoven structure wherein the density and/or thickness of the densified portion is different from the density and/or thickness of the lofty portion. The foregoing nonwoven structure wherein the densified portion being a needled and/or consolidated densified portion. The foregoing nonwoven structure wherein the consolidated densified portion includes a resin. The foregoing nonwoven structure wherein the lofty portion includes fiber to fiber bonding. The foregoing nonwoven structure wherein a laminate bond between the first batt and the second batt is glued and/or heat bonding. The foregoing nonwoven structure further comprising a resin impregnated in all or a portion of the batt. The foregoing nonwoven structure wherein the resin is heat-activatible. The foregoing nonwoven structure wherein the lofty portion of the first batt is bonded to the lofty portion of the second batt, or the densified portion of the first batt is bonded to the densified portion of the second batt, or the lofty portion of one batt is bonded to the densified portion of the other batt.

A nonwoven structure comprising: a first batt being a blend of staple fibers and binder fibers and the first batt having a densified skin on a first face of the first batt and a lofty body on a second face of the first batt, where the densified skin and the lofty body are formed from the fibers of the first batt and are not layers laminated together; a second batt being a blend of staple fibers and binder fibers and the second batt having a densified skin on a first face of the second batt and a lofty body on a second face of the second batt, where the densified skin and the lofty body are formed from the fibers of the second batt and are not layers laminated together; and the first batt is bonded to the second batt. The foregoing nonwoven structure wherein the staple fibers are a single staple fiber or a blend of two or more staple fibers. The foregoing nonwoven structure wherein the staple fibers include low melt temperature fibers or bi-component fibers. The foregoing nonwoven structure wherein the density and/or thickness of the densified skin is different from the density and/or thickness of the lofty body. The foregoing nonwoven structure wherein the densified skin being a needled and/or consolidated densified portion. The foregoing nonwoven structure wherein the consolidated densified portion includes a resin. The foregoing nonwoven structure wherein the lofty body includes fiber to fiber bonding. The foregoing nonwoven structure wherein a laminate bond between the first batt and the second batt is glued and/or heat bonding. The foregoing nonwoven structure further comprising a resin impregnated in all or a portion of the batt. The foregoing nonwoven structure wherein the resin is heat-activatible. The foregoing nonwoven structure wherein the lofty body of the first batt is bonded to the lofty body of the second batt, or the densified skin of the first batt is bonded to the densified skin of the second batt, or the lofty body of one batt is bonded to the densified skin of the other batt.

A method of making a nonwoven structure comprising the steps of: forming a first batting of a blend of staple fibers; forming a second batting of a blend of staple fibers; the first batting and the second batting are the same or different; densifying a first portion of the first batting to form a first partially densified nonwoven with a densified layer and a fluff layer; densifying a first portion of the second batting to form a second partially densified nonwoven with a densified layer and a fluff layer, laminating the first partially densified nonwoven to the second partially densified nonwoven, where the densified layer or the fluff layer of the first partially densified nonwoven is laminated to the densified layer or fluff layer of the second partially densified nonwoven. The foregoing method wherein forming the batt includes: air-laying, carding, but excludes wet-laying. The foregoing method wherein densifying includes: needling and/or heated nip rollers to activate bi-component fibers and/or resin and/or oven to activate bi-component fibers and/or resin, and/or a heated belt to activate bi-component fibers and/or resin.

The present invention may be embodied in other forms without departing from the spirit and the essential attributes thereof, and, accordingly, reference should be made to the appended claims, rather than to the foregoing specification, as indicating the scope of the invention.

I claim:

1. A method for covering a portable structure, the portable structure having a frame and a covering, comprises the step of:
providing the covering, the covering includes a nonwoven having a densified portion on a first face of the nonwoven and a lofty portion on a second face of the nonwoven, and a skin laminated on the nonwoven.

2. The method of claim 1 wherein the covering includes a first nonwoven having a densified portion and a lofty portion, a second nonwoven having a densified portion and a lofty portion, and a skin laminated on the first nonwoven or the second nonwoven.

3. The method of claim 2 wherein the densified portion and the lofty portion of either the first nonwoven or the second nonwoven are not individual layers laminated together.

4. The method of claim 1 wherein the skin is an external skin, an internal skin, or both.

5. The method of claim 1 wherein the nonwoven is made with a plurality of a single staple fiber or a blend of a plurality of two or more staple fibers.

6. The method of claim 5 wherein the staple fiber includes low melt temperature fibers or bi-component fibers.

7. The method of claim 1 wherein a density and/or a thickness of the densified portion is different from a density and/or a thickness of the lofty portion.

8. The method of claim 1 wherein the densified portion being a needled and/or consolidated densified portion.

9. The method of claim 8 wherein the consolidated densified portion includes a resin.

10. The method of claim 1 wherein the lofty portion includes fiber to fiber bonding.

11. The method of claim 2 wherein a laminate bond between the first nonwoven and the second nonwoven is glued and/or heat bonding.

12. The method of claim 1 further comprising a resin impregnated in all or a portion of the nonwoven.

13. The method of claim 12 wherein the resin is heat-activatible.

14. The method of claim 2 wherein the lofty portion of the first nonwoven is bonded to the lofty portion of the second nonwoven, or the densified portion of the first nonwoven is bonded to the densified portion of the second nonwoven, or the lofty portion of first nonwoven is bonded to the densified portion of the second nonwoven.

15. A nonwoven structure comprising:
a first batt is a blend of staple fibers, the first batt has a densified portion on a first face of the first batt and a lofty portion on a second face of the first batt, where the densified portion and the lofty portion are formed from the fibers of the first batt and are not layers laminated together;
a second batt is a blend of staple fibers, the second batt has a densified portion on a first face of the second batt and a lofty portion on a second face of the second batt, where the densified portion and the lofty portion are formed from the fibers of the second batt and are not layers laminated together; and
the first batt is laminated to the second batt.

16. A method of making a nonwoven structure comprising the steps of:
forming a first batting of a blend of staple fibers;
forming a second batting of a blend of staple fibers;
the first batting and the second batting are the same or different;
densifying a first portion of the first batting to form a first partially densified nonwoven with a densified layer and a fluff layer;
densifying a first portion of the second batting to form a second partially densified nonwoven with a densified layer and a fluff layer,
laminating the first partially densified nonwoven to the second partially densified nonwoven, where the densified layer or the fluff layer of the first partially densified nonwoven is laminated to the densified layer or fluff layer of the second partially densified nonwoven.

17. The process of claim 16 wherein forming the batt includes: air-laying, carding, but excludes wet-laying.

18. The process of claim 16 wherein densifying includes: needling and/or heated nip rollers to activate bi-component fibers and/or resin and/or oven to activate bi-component fibers and/or resin, and/or a heated belt to activate bi-component fibers and/or resin.
